(19) United States
(12) Patent Application Publication
(10) Pub. No.: US 2005/0069634 A1
(43) Pub. Date: Mar. 31, 2005

(54) Method for manufacturing master disk for magnetic transfer

(76) Inventor: Hiroyuki Yoshimura, Tokyo (JP)

Correspondence Address: RABIN & Berdo, PC, 1101 14TH STREET, NW, SUITE 500, WASHINGTON, DC, 20005, US

(21) Appl. No.: 10/900,401

(22) Filed: Jul. 28, 2004

(30) Foreign Application Priority Data
Sep. 25, 2003 (JP) JP PA 2003-333958

(51) Int. Cl. B05D 5/12

(52) U.S. Cl. 427/127

(57) ABSTRACT

A method for manufacturing a master disk for magnetic transfer, with which a soft magnetic material can be evenly embedded in the grooves of a master disk. A patterned groove is formed on the main surface of a silicon substrate, which is the substrate of a magnetic transfer master disk. A conductive thin film is formed on the main surface of the silicon substrate and the groove surfaces. With this conductive thin film as one electrode, a plating film of a soft magnetic material is deposited on the main surface of the silicon substrate and inside the grooves, on the bottom and sidewalls thereof, by electroplating. Then, just the soft magnetic material deposited on the main surface of the silicon substrate is removed by CMP, causing the soft magnetic material in the interior of the grooves to remain.

### BACKGROUND OF THE INVENTION

1. Field of the Invention

The invention relates to a method for manufacturing a master disk for magnetic transfer, and more particularly relates to a method for manufacturing a master disk for magnetic transfer, with which it is possible evenly to embed a soft magnetic material in the grooves of a master disk, and form a uniform soft magnetic layer over the entire master disk.

2. Background Art

With a hard disk drive (HDD), the recording and playback of data are performed in a state in which a magnetic head is levitated by a mechanism called a slider, and the gap between the magnetic head and the surface of a rotating magnetic recording medium is maintained at a few dozen nanometers. The bit information recorded on the magnetic recording medium is stored in data tracks arranged in concentric circles on the medium, and the recording and playback of data are performed by moving and positioning the magnetic head at high speed to the desired data tracks on the magnetic recording medium surface. Positioning signals (servo signals) for detecting the relative positions of the magnetic head and the data tracks are concentrically written on the magnetic recording medium surface, and the position of the magnetic head on the magnetic recording medium is detected at specific time intervals. These servo signals are written using a special device called a servo writer after the magnetic recording medium has been incorporated into the HDD device in order to keep the center of the write center from deviating from the center of the medium (or the center of the head trajectory).

With existing HDD-use magnetic recording media, the recording density at the development level has reached 100 Gbits per square inch, and recording capacity is increasing at a rate of 60% each year. As capacity thus increases, the write density of the servo signals for detecting the position of the magnetic head on the medium, and the write time of the servo signals, also tends to increase annually, and the increase in the write time of servo signals has been a major factor in driving up the cost and lowering the productivity in the manufacture of HDDs.

As for how servo signals are written using the signal write head of a servo writer, a technique has been developed whereby servo signals are written all at once by magnetic transfer, which dramatically reduces the time it takes to write servo signals, and there have been reports of methods for manufacturing a master disk for this purpose (see, for example, Japanese Patent Application Laid-Open Nos. 2001-034938 and 2003-022527).

FIGS. 5a and 5b are diagrams illustrating the steps involved in the magnetic transfer of servo signals. FIG. 5a shows how a permanent magnet for demagnetizing (not shown) is moved in the direction of the arrow in the drawing over the surface of a medium 51 at a constant distance of 1 mm or less in the initial demagnetization step. The magnetic layer provided to the medium 51 is not in a state of being magnetized in a specific direction prior to this step, but is evenly magnetized in the circumferential direction, as indicated by the arrow in the drawing, by the magnetic field that leaks out from the gap of the permanent magnet. FIG. 5b shows the state when positioning is performed by disposing a magnetic transfer master disk 52 over the medium 51 in a master disk positioning step. FIG. 5c shows how the master disk 52 is pressed against the surface of the medium 51 in a transfer pattern write step, and the magnetic transfer of servo signals is performed by moving a magnetic transfer permanent magnet (not shown) along the movement path indicated by the arrow in the drawing.

FIGS. 6a and 6b are diagrams illustrating the relative positional relationship between the medium and the permanent magnet in the initial demagnetization step and the transfer pattern write step of the magnetic transfer of the servo signals. FIG. 6a shows the positional relationship in the initial demagnetization step, while FIG. 6b shows the positional relationship in the transfer pattern write step. In the initial demagnetization step, as shown in FIG. 6a, a demagnetizing permanent magnet 53 is moved in the direction of the arrow in the drawing over the surface of the medium 51, which comprises a magnetic layer 51b over a substrate 51a. In this step, the magnetic layer 51b is evenly magnetized in the circumferential direction, as indicated by the arrow in the drawing, by the magnetic field that leaks out from the gap of the permanent magnet 53.

In the transfer pattern write step, as shown in FIG. 6b, the surface on the soft magnetic film side of the master disk 52 is disposed in contact with the surface on the magnetic layer side of the medium 51. The soft magnetic film comprises a soft magnetic film 52b with an embedded cobalt-based soft magnetic layer on one side of a silicon substrate 52a. The magnetic transfer permanent magnet 53 is scanned over the silicon substrate 52a in the direction shown. Since the soft magnetic film 52b, with its cobalt-based soft magnetic layer embedded in a pattern, is interposed between the permanent magnet 53 and the magnetic layer 51b, the magnetic field formed in the silicon substrate 52a by the permanent magnet 53 is able to magnetize the magnetic particles at sites in the magnetic layer 51b corresponding to positions in the soft magnetic film 52b only where there is no cobalt-based magnetic layer. At sites in the magnetic layer 51b corresponding to positions where the cobalt-based magnetic layer is present, the magnetic field leaking out from the silicon substrate 52a becomes weaker because it passes through the soft magnetic film 52b so as to create a magnetic path with low magnetic resistance, and no new signal writing is performed. Magnetic transfer is carried out by this mechanism. As shown in FIG. 6b, the orientation of the magnetic field during the transfer signal writing is opposite that of the demagnetization field.

FIGS. 7a-7h are diagrams illustrating the standard steps in producing a master disk. The first step is for the formation of a thermal oxide film (FIG. 7a), in which a SiO₂ film 71 with a thickness of 0.2 μm is formed by subjecting the surface of the silicon substrate 52a to a thermal oxidation treatment.

The second step is for the application of a resist (FIG. 7b), in which the SiO₂ film 71 of the silicon substrate 52a that has undergone the thermal oxidation treatment is coated with a photoresist 72 in a thickness of 0.2 μm. As discussed below, during subsequent etching, the etching rate with an oxide film etching apparatus is such that a ratio of photoresist to SiO₂ is 1:2. Therefore, a thickness of about 0.2 μm is adequate for the photoresist used to etch the SiO₂ film formed to a thickness of 0.2 mm in the first step.

The third step is a patterning step to form a magnetic pattern (FIG. 7c). In this step, the photoresist surface of the silicon substrate 52a is exposed using an electron beam exposure apparatus or the like, the photoresist 72 is photosensitized in the desired pattern, and the photoresist surface is immersed in a developing solution to remove the exposed portion.

The fourth step is a step of etching the SiO₂ film 71, in which the SiO₂ film exposed by the removal of the photoresist is etched with an oxide film etcher, and the etching is halted at the point that the surface of the silicon substrate 52a becomes exposed. This transfers the pattern formed on the photoresist 72 to the SiO₂ film 71.

The fifth step is for removal of photoresist (FIG. 7e), in which the remaining photoresist film is ashed and removed by heating. By this step, the mask of the patterned SiO₂ film 71 is exposed.

The sixth step (FIG. 7f) uses a silicon etching apparatus to etch the silicon substrate 52a. The SiO₂ film serves as a mask, so that the etching is performed where the surface of the silicon substrate 52a is exposed, to form grooves of a specific depth.

The seventh step (FIG. 7g) is for forming a soft magnetic film. A sputtering apparatus that affords high linearity of the sputtered film particles is used to form a soft magnetic film 73 such that the film covers the entire surface of the silicon substrate 52a. This embeds the soft magnetic material in the grooves formed in the sixth step.

The eighth step (FIG. 7h) is a CMP step. The soft magnetic film 73 formed in the seventh step is subjected to CMP (Chemical Mechanical Polishing), and the soft magnetic material is removed from everywhere but the grooves formed in the sixth step. This completes the embedding of the soft magnetic material in the grooves provided to the silicon substrate 52a.

In this production procedure, the reason that the soft magnetic film 73 is polished away by CMP after it is first formed so as to extend adequately beyond the surface of the SiO₂ film 71 is so that the surface of the soft magnetic material embedded in the grooves provided to the silicon substrate 52a will be positioned in the same plane as the surface of the SiO₂ film 71. The rate at which the soft magnetic film 73 is polished by CMP is about 100 times the rate at which the SiO₂ is polished, so the amount of residual polishing at the stage when the surface of the SiO₂ film 71 has been exposed is actually quite small. Estimation is used at this stage to determine when to halt the CMP.

A problem encountered with the conventional method for master disk production described above is that with large-diameter master disks of 2.5 to 3.5 inches in diameter, the soft magnetic material is not evenly embedded into the grooves around the outside of the disk.

FIGS. 8a-8c are diagrams illustrating the results of examining the shape in which the soft magnetic material is embedded into the grooves in the radial direction of the substrate, and consists of oblique views (SEM images) midway through the embedding of the soft magnetic material. FIG. 8a shows the interior of a groove located in the center of the substrate. FIG. 8b is an image at 16.4 mm from the substrate center. FIG. 8c is an image at 32.8 mm from the substrate center. At the substrate center of the master disk (FIG. 8a), the soft magnetic material is embedded uniformly in the groove. However, toward the outer periphery of the substrate of the master disk the embedding of the soft magnetic material becomes increasingly less complete. The substrate periphery corresponds in the drawings to the shadows of the sidewalls of the groove. The reason for this is that as the distance from the substrate center to the substrate outer periphery increases, there is a steady increase in the angle formed by the flight direction of the sputtered particles and the sidewalls of the groove (the angle of incidence limit). The sputtering of the soft magnetic material was continued in this state until enough soft magnetic material had been deposited to thoroughly cover the surface of the SiO₂ film, after which the soft magnetic layer everywhere but inside the grooves was removed by CMP.

FIG. 9 is a cross-sectional view near a groove located at the outer periphery of the substrate. It can be seen that the embedding of the soft magnetic material is incomplete at the sidewalls of the groove. When magnetic transfer is performed using a master disk with incomplete embedding of the soft magnetic material such as this, sub-pulses are generated in the playback signals of the magnetic recording medium after magnetic transfer, resulting in a loss of magnetic transfer stability.

FIGS. 10a and 10b are graphs illustrating the playback signal obtained from a magnetic recording medium in which a magnetic pattern had been formed by magnetic transfer. FIG. 10a shows a normal playback signal, while FIG. 10b shows a playback signal including sub-pulses. It can be seen that the playback signal shown in FIG. 10b includes, in addition to the normal playback signal, pulses that should not be there (sub-pulses), at the places indicated by the arrows in the graph. This playback signal is caused by incomplete embedding of the soft magnetic material into the grooves of the master disk. Thus, obtaining higher magnetic transfer stability requires finding a way uniformly and completely to embed the soft magnetic material in the grooves over the entire master disk.

### OBJECTS AND SUMMARY OF THE INVENTION

The invention was conceived in light of these problems, and its object is to solve them. Therefore, a method for manufacturing a master disk for magnetic transfer according to the invention should provide a method, with which a soft magnetic material is evenly embedded in the grooves of a master disk provided with a textured patterned on its main surface. A soft magnetic layer should be uniformly formed over the entire master disk. As a result, sub-pulses should be suppressed in the playback signals obtained from a magnetic recording medium after magnetic transfer, which would stabilize the magnetic transferability of the master disk.

In order to achieve the stated object, a first embodiment of the invention is a method for manufacturing a master disk for magnetic transfer, in which a first step is to form a patterned groove on the main surface of the substrate of a magnetic transfer master disk. A second step is to form a conductive thin film on the main surface of the substrate and on the interior portion of the groove. A third step is to deposit a soft magnetic material on the main surface of the substrate and on the groove surface by electroplating, wherein the conductive thin film serves as one of the electrodes. A fourth step is to remove the soft magnetic material deposited on the main surface of the substrate by CMP, and cause the soft magnetic material to remain on just the interior portion of the groove.

The second embodiment is a method for manufacturing a master disk for magnetic transfer, which includes a first step of forming a patterned groove on the main surface of the substrate of a magnetic transfer master. A second step is to form a conductive thin film on the main surface of the substrate and on the groove surface. A third step is to remove the conductive thin film on the main surface of the substrate by lift-off, and cause the conductive thin film to remain on just the interior portion of the groove. A fourth step is to deposit a soft magnetic material in the interior portion of the groove by electroplating in which the conductive thin film serves as the base.

With the invention, a soft magnetic material is evenly embedded in the grooves of a master disk provided with a textured patterned on its main surface, a soft magnetic layer is uniformly formed over the entire master disk, and sub-pulses are suppressed in the playback signals obtained from a magnetic recording medium after magnetic transfer. As a result, it is possible to stabilize the magnetic transferability of the master disk.

### BRIEF DESCRIPTION OF THE DRAWINGS

FIGS. 1a-1i are diagrams illustrating the steps entailed by the method of the invention for manufacturing a magnetic transfer master disk.

FIG. 2 is a diagram illustrating more specifically the electroplating step.

FIG. 3 is a diagram illustrating an example of performing electroplating with conductive plates disposed at the sidewalls around the outer periphery of the master disk.

FIGS. 4a-4h are diagrams illustrating the steps entailed by the method in Example 2 for manufacturing a master disk for magnetic transfer.

FIGS. 5a-5c are diagrams illustrating the steps involved in the magnetic transfer of servo signals, with FIG. 5a being a diagram of the initial demagnetization step, FIG. 5b the master disk positioning step, and FIG. 5c the transfer pattern write step.

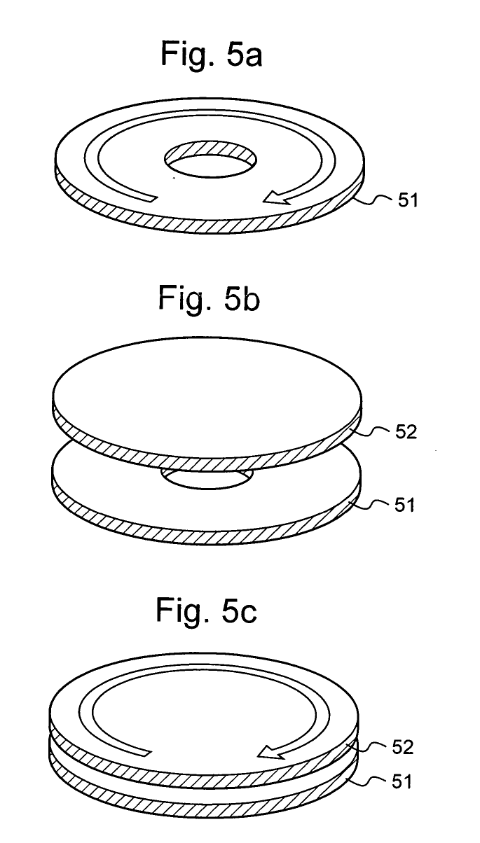

FIGS. 6a and 6b are diagrams illustrating the relative positional relationship between the medium and the permanent magnet in the initial demagnetization step and the transfer pattern write step of the magnetic transfer of the servo signals, with FIG. 6a showing the positional relationship in the initial demagnetization step, and FIG. 6b the positional relationship in the transfer pattern write step.

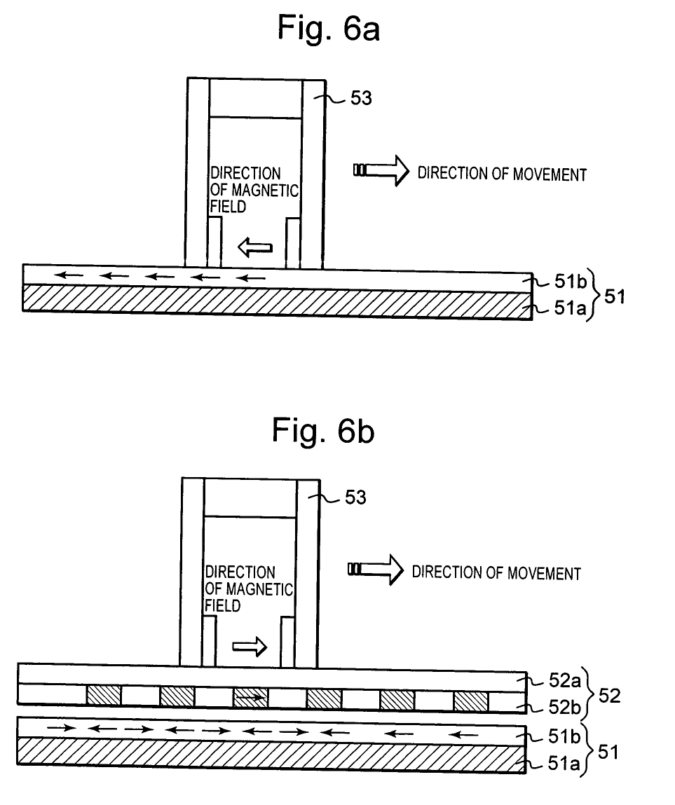

FIGS. 7a-7h are diagrams illustrating the standard steps in producing a master disk.

FIGS. 8a, 8b and 8c are diagrams illustrating the results of examining the shape in which the soft magnetic material is embedded into the grooves in the radial direction of the substrate, and consists of oblique views (SEM images) of midway through the embedding of the soft magnetic material, wherein FIG. 8a shows the interior of a groove located in the center of the substrate, FIG. 8b shows the interior of the groove at 16.4 mm from the substrate center, and FIG. 8c shows the interior of the groove at 32.8 mm from the substrate center.

FIG. 9 shows the cross-sectional shape near a groove located at the outer periphery of the substrate.

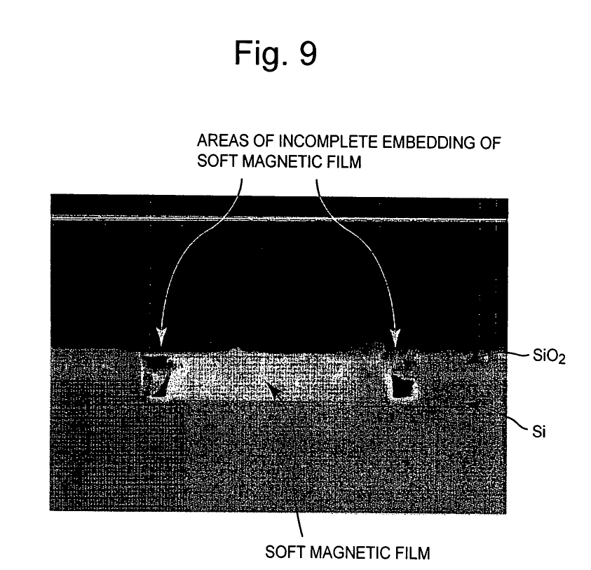

FIGS. 10a and 10b are graphs illustrating the playback signal obtained from a magnetic recording medium in which a magnetic pattern was formed by magnetic transfer, with FIG. 10a being a normal playback signal, and FIG. 10b a playback signal including sub-pulses.

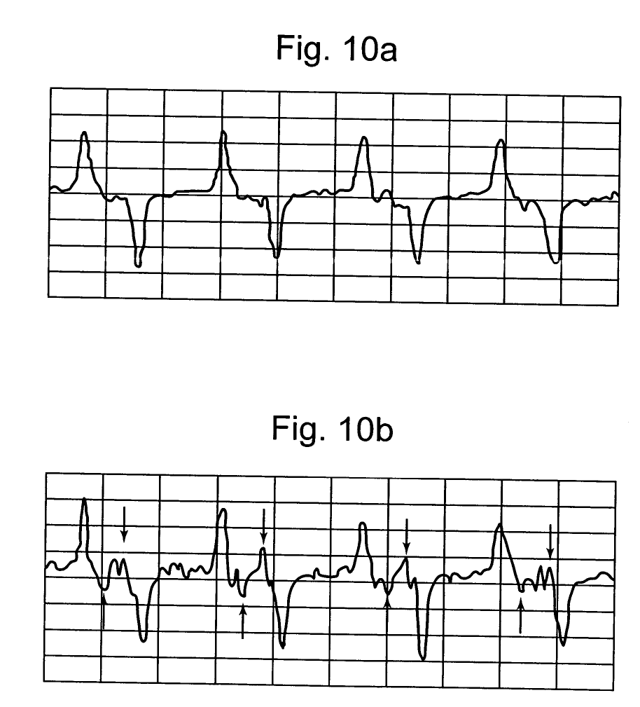

### DETAILED DESCRIPTION OF THE PREFERRED EMBODIMENTS

Embodiments of the invention will now be described with reference to the drawings.

### Example 1

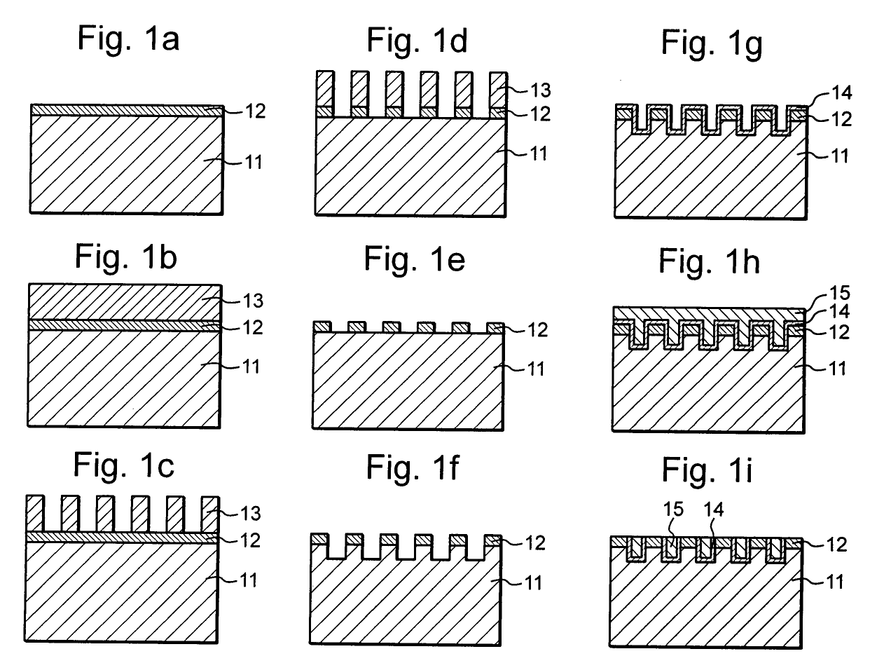

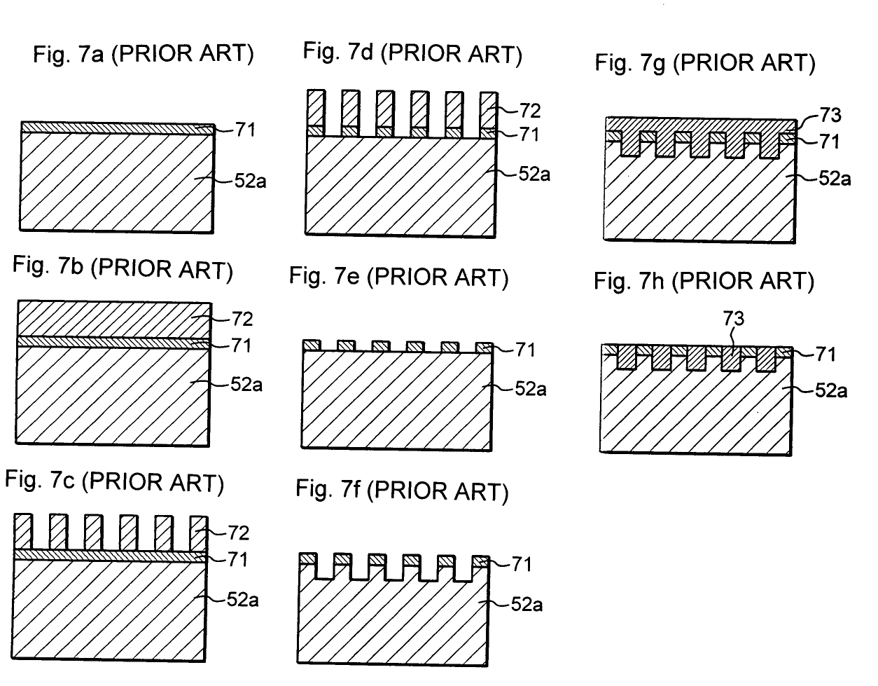

FIGS. 1a-1i are diagrams illustrating the steps of the method of the invention for manufacturing a magnetic transfer master disk. A difference from the conventional manufacturing method shown in FIGS. 7a-7h is that a soft magnetic film is formed by electroplating.

In the first step shown in FIG. 1a, a thermal oxide film is formed. In particular, a SiO₂ film 12 with a thickness of 0.2 μm is formed by subjecting the surface of a silicon substrate 11 to a thermal oxidation treatment.

In the second step shown in FIG. 1b, a resist is applied. In particular, the SiO₂ film 12 of the silicon substrate 11 that has undergone the thermal oxidation treatment is coated with a photoresist 13 in a thickness of 0.2 μm. As discussed above, the etching rate with an oxide film etching apparatus is such that photoresist: SiO₂=1:2, so a thickness of about 0.2 μm is adequate for the photoresist used to etch the SiO₂ film formed in a thickness of 0.2 μm in the first step.

In the third step shown in FIG. 1c, patterning is performed to obtain a magnetic pattern. In particular, the photoresist surface of the silicon substrate 11 is exposed using an electron beam exposure apparatus or the like, the photoresist 13 is photosensitized in the desired pattern, and the photoresist surface is immersed in a developing solution to remove the exposed portion.

In the step fourth shown in FIG. 1d, the SiO₂ film 12 is etched. In particular, the SiO₂ film exposed by the removal of the photoresist is etched with an etching gas comprising a mixture of oxygen gas and CHF₃ gas in an oxide film etcher, and the etching is halted at the point when the surface of the silicon substrate 11 has been exposed. This transfers the pattern formed on the photoresist 13 to the SiO₂ film 12.

In the fifth step shown in FIG. 1e, photoresist is removed. In particular, the remaining photoresist film is ashed and removed by heating, and the mask of the patterned SiO₂ film 12 is exposed.

In the sixth step shown in FIG. 1f, silicon is etched. In particular, the SiO₂ film is used as a mask in the etching of the portion where the surface of the silicon substrate 11 is exposed, with a silicon etching apparatus and in an SF₆ gas atmosphere, to form grooves to a specific depth.

In the seventh step shown in FIG. 1g, a conductive thin film is formed. In particular, a conductive thin film 14 is formed by sputtering on the silicon substrate 11, and this conductive thin film is used as the electroplating electrode in the next step. As shown in FIG. 1g, the conductive thin film is formed not only on the bottom, but also on the sidewalls of the grooves formed in the silicon substrate 11, so voltage is reliably applied to the entire surface of the grooves in the electroplating step.

In the eighth step shown in FIG. 1h, a soft magnetic film is formed. In particular, a voltage is applied to the electroplating electrode of the conductive thin film 14 formed on the silicon substrate 11 by immersion into a plating solution in which a soft magnetic material has been dissolved, and a plating film 15 of the soft magnetic material is formed in the grooves and on the surface of the silicon substrate 11. As already described, since a voltage is reliably applied over the entire surface of the grooves in the electroplating step, the soft magnetic material is reliably embedded in the interior of the grooves. In this plating step, there is a danger that the soft magnetic material adhering to the upper surfaces of the grooves will block the grooves, so an additive must be added to the plating solution so that the plating film will be formed from the bottom of the grooves.

In the ninth step shown in FIG. 1i, chemical-mechanical polishing (CMP) is performed. In particular, the soft magnetic film 15 formed in the eighth step is subjected to CMP, and the soft magnetic material is removed from everywhere but the grooves formed in the sixth step. This completes the embedding of the soft magnetic material in the grooves provided to the silicon substrate 11.

In this CMP step, it is possible to ascertain ahead of time the polishing rate of the SiO₂ film and the polishing rate of the cobalt or other magnetic film by CMP, and to estimate the polishing time on the basis of the thickness of the soft magnetic film deposited on the SiO₂ film. However, in actual practice, the polishing is performed slightly longer than the estimated polishing time to be on the safe side. Early in the polishing, the soft magnetic film deposited on the SiO₂ film is ground down, but the polishing speeds up when the soft magnetic film is polished away and the SiO₂ film appears at the surface.

CMP was performed in the production of a master disk on which a pattern had been formed in a width of 3 μm. As a result, it was confirmed that the polishing rate of the SiO₂ film was much lower than the polishing rate of the soft magnetic film (cobalt), so the polished surface position substantially coincided with the SiO₂ surface position, and the surface of the soft magnetic material was depressed by about 0.06 μm. However, if the servo pattern width is narrowed to the current 0.2 μm equivalent, there should be a considerable reduction in the above-mentioned depression of the soft magnetic material surface, and no decrease in magnetic transfer performance should occur.

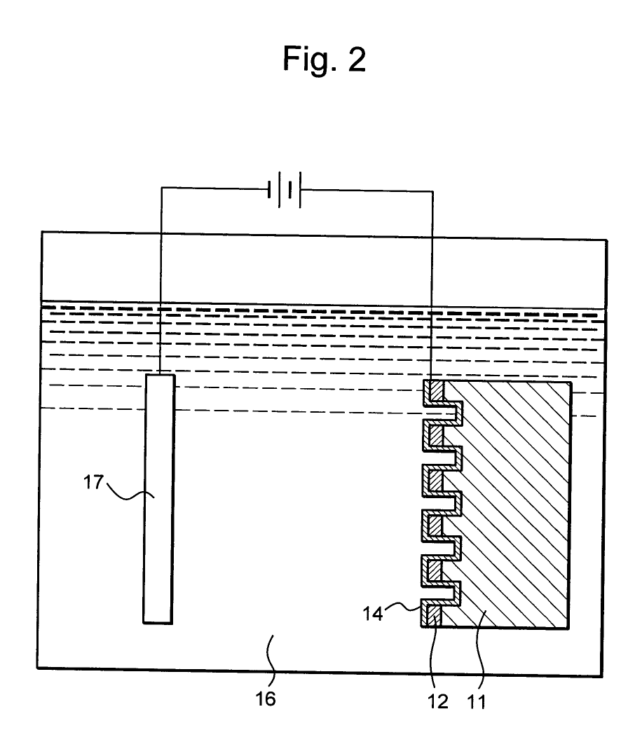

FIG. 2 is a diagram illustrating more specifically the electroplating step of the above-mentioned eighth step. The silicon substrate 11 is immersed in a plating solution 16 in which a soft magnetic material has been dissolved. The electroplating electrode of the conductive thin film 14 is disposed parallel to a counter electrode 17 of the same size as the master disk (silicon substrate 11). A voltage is applied in this state, and a plating film of a soft magnetic material is formed in the grooves and on the surface of the silicon substrate 11.

In order to keep the thickness of the plating film uniform here, it is extremely important that the counter electrode 17 and the electroplating electrode be precisely disposed parallel to each other, and that the electric field be uniform in the plane of the master disk. In this drawing, a positive voltage is applied to the electroplating electrode of the conductive thin film 14, and a negative voltage is applied to the counter electrode 17. However, the polarity of the applied voltage can be suitably varied according to the plating solution 16 and other such conditions.

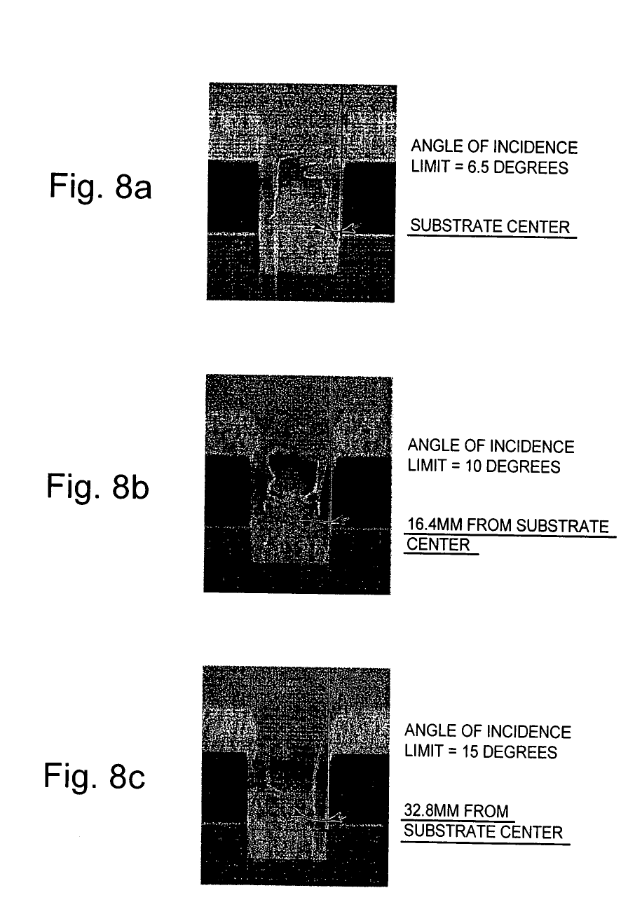

When a soft magnetic film is formed by sputtering as in a conventional method, even if a large-diameter target is used, the sputtered particle density distribution is higher near the target center and lower toward the outer periphery, and this results in the soft magnetic material being unevenly embedded as shown in FIGS. 8a, 8b and 8c. In contrast, when the embedding of the soft magnetic material is accomplished by electroplating as in the invention, a voltage is reliably applied to the entire surface of the grooves, and the soft magnetic material is reliably embedded in the interior of the grooves.

In this plating step, basically, the thickness of the plating film will be uniform as long as the electric field intensity is the same over the entire master disk (silicon substrate 11). However, the problem is that the electric field tends to accumulate around the outer periphery, and the plating film tends to be thicker in this portion.

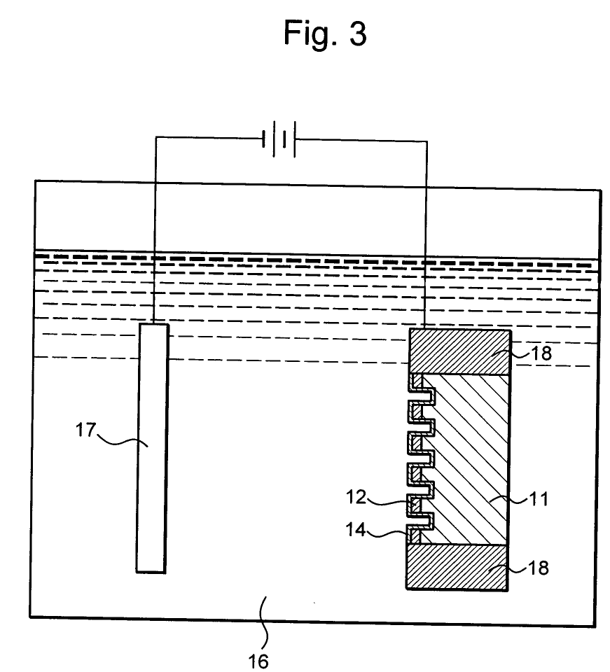

FIG. 3 is a diagram illustrating an example of performing the electroplating with conductive plates 18 disposed at the sidewalls around the outer periphery of the master disk (silicon substrate 11) in order to avoid the above problem. As discussed above, it is the tendency of the electric field to accumulate around the outer periphery that results in the tendency of the plating film to be thicker in this same portion. Therefore, if, as shown in FIG. 3, the conductive plates 18 are disposed at the sidewalls around the outer periphery of the master disk (silicon substrate 11), and if the outside diameter of the counter electrode is the same as the outside diameter of the master disk including the conductive plates 18, then it will be possible to form an even electric field in every region of the master disk, and there will be no unevenness in the thickness of the plating film.

### Example 2

In this example, a soft magnetic film is formed by electroless plating. Electroless plating is a plating method based on a pure chemical reaction, in which metal ions are reduced and precipitated by a reducing agent contained in the plating solution, but as long as metal ions and a reducing agent both are present, the precipitation of a plating film also will occur as the result of the self-catalytic action of the precipitated metal itself.

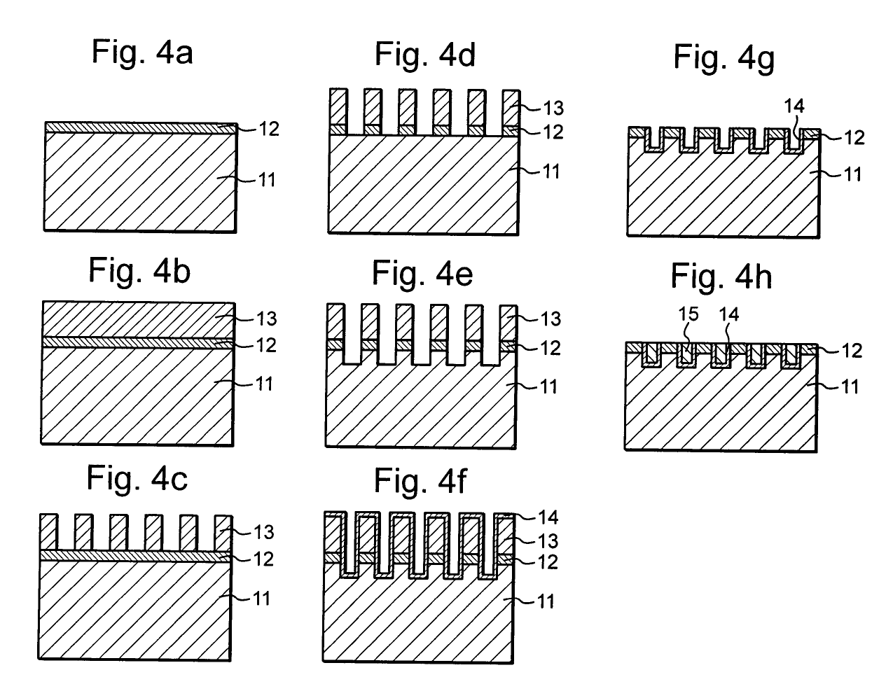

FIGS. 4a-4h are diagrams illustrating the steps entailed by the method in this example for manufacturing a master disk for magnetic transfer. The first to fourth steps (FIGS. 4a to 4d) are the same as the first to fourth steps in Example 1, which are shown in FIGS. 1a to 1d, and therefore will not be described again.

In the fifth step shown in FIG. 4e, silicon etching is performed. In particular, the SiO₂ film 12 is used as a mask in the etching of the portion where the surface of the silicon substrate 11 is exposed, with a silicon etching apparatus and in an SF₆ gas atmosphere, to form grooves to a specific depth.

In the sixth step shown in FIG. 4f, a conductive thin film is formed. In particular, a conductive thin film 14 is formed by sputtering on the sides and bottom of the grooves and the surface of the silicon substrate 11.

In the seventh step shown in FIG. 4g, sputtering is performed on the conductive thin film. In particular, hydrofluoric acid is made to permeate from the sidewalls of the grooves, and the resist 13 remaining on the surface of the silicon substrate 11 is removed by lift-off, leaving the conductive thin film only in the grooves.

In an eighth step shown in FIG. 4h, electroless plating is performed. In particular, the silicon substrate 11 that has undergone the seventh step is immersed in a plating solution in which a soft magnetic material has been dissolved and which contains a reducing agent. The soft magnetic material dissolved in the plating solution is precipitated until a sufficient thickness is reached with respect to the depth of the grooves. When the soft magnetic material is precipitated somewhere other than in the grooves, the soft magnetic material on those portions other than the grooves is removed by CMP. This completes the embedding of the soft magnetic material into the grooves provided to the silicon substrate 11.

Again in this plating step, there is a danger that the soft magnetic material adhering to the upper surfaces of the grooves will block the grooves. Therefore, an additive must be added to the plating solution so that the plating film will be formed from the bottom of the grooves.

The entire disclosure of applicant's corresponding Japanese patent application, No. JP 2003 333958, filed Sep. 25, 2003, is incorporated herein by reference.

1. A method for manufacturing a master disk for magnetic transfer, comprising:
a first step of forming a patterned groove on a main surface of a substrate of a magnetic transfer master disk;
a second step of forming a conductive thin film on the main surface of the substrate and on a surface of the patterned groove;
a third step of depositing a soft magnetic material on the main surface of the substrate and on an interior portion of the groove by electroplating, wherein the conductive thin film serves as an electrode; and
a fourth step of removing the soft magnetic material deposited on the main surface of the substrate by CMP, and causing the soft magnetic material to remain on just the interior portion of the groove.

2. A method for manufacturing a master disk for magnetic transfer, comprising:
a first step of forming a patterned groove on a main surface of a substrate of a magnetic transfer master disk;
a second step of forming a conductive thin film on the main surface of the substrate and on a surface of the patterned groove;
a third step of removing the conductive thin film on the main surface of the substrate by lift-off, and causing the conductive thin film to remain on just an interior portion of the groove; and
a fourth step of depositing a soft magnetic material in the interior portion of the groove by electroplating, wherein the conductive thin film serves as a base.
